(19) United States
(12) Patent Application Publication
(10) Pub. No.: US 2015/0321896 A1
(43) Pub. Date: Nov. 12, 2015

(54) BEER SERVER

(71) Applicant: ASAHI BREWERIES, LTD., Tokyo (JP)

(72) Inventors: Keizo KOBAYASHI, Tokyo (JP); Takeshi KAMIMURA, Tokyo (JP); Masatake TAGUCHI, Moriya-shi, Ibaraki (JP); Yoshinori SATO, Moriya-shi, Ibaraki (JP)

(21) Appl. No.: 14/649,641

(22) PCT Filed: Nov. 20, 2013
(86) PCT No.: PCT/JP2013/081269

§ 371 Date: Jun. 4, 2015

(30) Foreign Application Priority Data
Jan. 24, 2013 (JP) 2013-011018

(51) Int. Cl. B67D 1/08; B67D 1/00

(52) U.S. Cl. CPC B67D 1/0864; B67D 1/0004; B67D 1/0878; B67D 1/0888

(57) ABSTRACT

A compact, inexpensive, and low-power-consumption beer server that controls beer temperature at nearly 0° C. and prevents the beer from freezing. The beer server includes a beer tank 12, a primary cooling tank 16, and a secondary cooling tank 18. Beer in the beer tank 12 is cooled to 2 to 5° C. in the primary cooling tank 16. Thereafter, the beer is cooled to 0° C. in the secondary cooling tank 18. A control unit 50 controls agitation fins 22 so that a beer temperature T₁ at an outlet of the primary cooling tank 16 is a predetermined temperature of 2 to 5° C. The secondary cooling unit 18 is composed of two heat exchangers 30a and 30b. The control unit 50 controls refrigerant supplied to heat exchangers 30a and 30b so that a beer temperature T₂ at an outlet of the secondary cooling tank 18 is a predetermined temperature of nearly 0° C.

### TECHNICAL FIELD

The present invention relates to a beer server that can cool beer at a temperature of around 0° C. and serve the cold beer.

### BACKGROUND

Beer servers that pour cold beer from a dispensing nozzle to vessels are categorized as air-cooled beer servers and water-cooled beer servers. A water-cooled beer server has a cooling tank that is filled with cooling water. Disposed in the cooling tank are a coil-shaped beer cooling pipe and a refrigerant evaporation pipe. Low temperature refrigerant is supplied from a freezer to the refrigerant evaporation pipe so that cooling water is cooled and beer that flows in the beer cooling pipe is cooled at around 4 to 6° C. The cold beer is poured from a dispensing nozzle to mugs. A water-cooled beer server can cool beer more quickly than an air-cooled beer server. Patent Document 1 discloses a water-cooled beer server having the foregoing structure.

Draft beer cooled at around 0° C. is more favored than beer cooled in the foregoing temperature range because draft beer has clear taste, fizzy stimulation of soda, sharpness, and refreshment. Patent Documents 2 and 3 disclose beer servers that can serve beer cooled at around 0° C. The beer server disclosed in Patent Document 2 also has a secondary cooling tank that is filled with antifreeze in addition to a primary cooling tank that is the foregoing cooling tank. Beer cooled in the primary cooling tank is caused to flow in a cooling pipe of the secondary cooling tank filled with antifreeze so as to cool beer at nearly 0° C.

The beer server disclosed in Patent Document 3 has a secondary cooling unit including a block made of a metal having high heat conductivity along with the foregoing primary cooling tank. Disposed in the block are a beer cooling pipe and a refrigerant evaporation pipe. The block is cooled at 0° C. or below by low temperature refrigerant that flows in the refrigerant evaporation pipe. Beer cooled in the primary cooling tank is caused to flow in the beer cooling pipe disposed in the block so as to cool beer at around 0° C.

### CITATION LIST

### Patent Literature

Patent Document 1: Japanese Patent Application Laid-open No. 2007-303790

Patent Document 2: Japanese Patent Application Laid-open No. 2003-26292

Patent Document 3: Japanese Patent Application Laid-open No. 2003-28552

### SUMMARY

### Technical Problem

When beer is cooled to around 0° C., the beer is frozen at around −3° C. Thus, when beer is cooled, a strict temperature control is required for beer. In other words, unless a heat load of a primary cooling process and a heat load of a secondary cooling process are well balanced, a beer serving temperature cannot be accurately adjusted. For example, if the heat load in the primary cooling process is too large, the temperature of cooling water in the primary cooling process rises. As a result, after the secondary cooling process, the beer temperature rises. In contrast, if beer is excessively cooled in the primary cooling process, after the second cooling process, the beer is likely to be frozen.

Patent Document 2 describes the beer server that includes a temperature sensor that detects the temperature of antifreeze filled in the secondary cooling tank and a control unit that controls an operation of a freezer and adjusts the temperature of antifreeze to a desired temperature. However, as described above, the heat load of the primary cooling process and the heat load of the secondary cooling process need to be well balanced. If only the temperature of antifreeze filled in the secondary cooling tank is adjusted, the beer temperature at the secondary cooling outlet cannot be accurately controlled. Patent Document 3 also describes the beer server that has a temperature sensor that detects the temperature of the block and a control unit that controls an operation of a freezer and the temperature of the block to a desired temperature. However, likewise, it is difficult to accurately control the beer temperature at an outlet of the secondary cooling unit by controlling only the temperature of the block.

The beer server disclosed in Patent Document 2 needs to cool a relatively large amount of antifreeze filled in the secondary cooling tank. Thus, the beer server needs to use a freezer having a large freezing capacity and a large space. Such a freezer is not suitable for small restaurants that have only a 100 V power supply. Likewise, since the beer server disclosed in Patent Document 3 needs to cool the block having a relatively large heat capacity to 0° C. or below, the beer server also needs a freezer having a large freezing capacity. Thus, the beer server disclosed in Patent Document 3 also has the same problem as the beer server disclosed in Patent Document 2.

The present invention is made from the foregoing point of view. An object of the present invention is to provide a compact, inexpensive, and low-power-consumption beer server that accurately controls a beer temperature so as to serve beer at nearly 0° C. and prevent the beer from being frozen.

### Solution to Problem

To accomplish the foregoing object, a beer server according to the present invention includes a beer tank that stores beer, a primary cooling unit having a cooling tank storing cooling water, an agitator that agitates the cooling water, a beer cooling pipe disposed in the cooling water and through which the beer flows from the beer tank, and a refrigerant evaporation pipe disposed in the cooling water, a secondary cooling unit having a heat exchanging part that directly exchanges heat between the beer primarily cooled by the primary cooling unit and a refrigerant not through a heat medium so as to secondarily cool the beer, a dispensing nozzle that dispenses the beer cooled by the secondary cooling unit, a freezer that supplies a low temperature refrigerant to the refrigerant evaporation pipe of the primary cooling unit and to the secondary cooling unit, a first temperature sensor that detects a beer temperature at an outlet of the primary cooling unit, a second temperature sensor that detects a beer temperature at an outlet of the secondary cooling unit, and a control unit into which detected values of the first temperature sensor and the second temperature sensor are inputted, the control unit being configured to control an operation of the agitator to set the beer temperature at the outlet of the primary cooling unit to a predetermined value, and to control an amount of the refrigerant supplied to the second cooling unit to set the beer temperature at the outlet of the secondary cooling unit to a predetermined value.

According to the present invention, the detected value of the first temperature sensor is input to the control unit. The control unit controls the operation of the agitator so that the beer temperature at the outlet of the primary cooling unit becomes the predetermined value. In addition, the detected value of the second temperature sensor is input to the control unit. The control unit controls the amount of refrigerant supplied to the heat exchanging part of the second cooling unit. Since the second cooling unit exchanges heat between beer and refrigerant not through a heat medium, the beer is likely to be frozen. In contrast, according to the present invention, since the beer temperature at the outlet of the primary cooling unit and the beer temperature at the outlet of the secondary cooling unit are controlled at the predetermined values, the heat load of the primary cooling unit and the heat load of the secondary cooling unit can be well balanced. Thus, the beer temperature at the outlet of the secondary cooling unit can be accurately controlled. As a result, the beer server according to the present invention can lower the beer serving temperature to nearly 0° C. without freezing the beer.

Thus, since the beer server according to the present invention can accurately control the beer serving temperature, the beer server does not need to excessively cool the refrigerant and beer. In addition, since the heat exchanging part directly exchanges heat between the beer and the refrigerant not through the heat medium, the heat load of the beer service is lower than the heat load of the beer server disclosed in each of Patent Document 2, Patent Document 3, and so on. As a result, the power consumption of the freezer can be reduced. Thus, since the beer server according to the present invention can use a freezer having a low capacity. As a result, since the beer server can use a freezer having a low capacity, the secondary cooling unit becomes compact and inexpensive. Thus, small restaurants that have only a 100 V power supply can use the beer server according to the present invention.

According to the present invention, the heat exchanging part of the secondary cooling unit desirably includes a plurality of heat exchangers disposed in series in a flow path of the beer. The beer server desirably includes refrigerant supply pipes and flow rate adjustment valves, the refrigerant supply pipes being disposed in parallel with the primary cooling unit and the plurality of heat exchangers and configured to supply the low temperature refrigerant from the freezer to each of the plurality of heat exchangers and the refrigerant evaporation pipe of the primary cooling unit, and the flow rate adjustment valves being disposed in the respective refrigerant supply pipes. The control unit desirably controls opening degrees of the flow rate adjustment valves so as to control the amounts of the refrigerant supplied to the plurality of heat exchangers.

The heat exchanging part of the secondary cooling unit is separated into a plurality of heat exchangers and the amounts of refrigerant supplied to the heat exchangers are adjusted by flow rate adjustment valves. Thus, the beer temperatures at the outlets of the individual heat exchangers can be easily controlled. As a result, the beer temperature at the outlet of the secondary cooling unit can be more accurately controlled. The flow rate adjustment valves are switch valves that control the amount of refrigerant that flows. The flow rate adjustment valves include switch valves that control an open period or a close period.

According to the present invention, the control unit desirably causes the low temperature refrigerant to be supplied to the refrigerant evaporation pipe of the primary cooling unit in a non-operating time of the beer server so that only a predetermined amount of ice is stored in the primary cooling unit. Thus, when ice is formed in the primary cooling unit in the non-operating time such as at midnight, daytime peak power consumption can be reduced.

### Advantageous Effects

According to the present invention, since the beer temperature at the outlet of the primary cooling unit and the beer temperature at the outlet of the secondary cooling unit are controlled to be predetermined values, the beer can be accurately cooled to nearly 0° C., not frozen. Thus, since the refrigerant and beer do not need to be excessively cooled, power of the freezer can be reduced.

### BRIEF DESCRIPTION OF DRAWINGS

FIG. 1 is a schematic diagram illustrating an overall structure of a beer server according to a first embodiment of the present invention.

FIG. 2 is a flow chart illustrating a first half of a control procedure of the beer server according to the first embodiment of the present invention.

FIG. 3 is a flow chart illustrating a second half of the control procedure of the beer server according to the first embodiment of the present invention.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

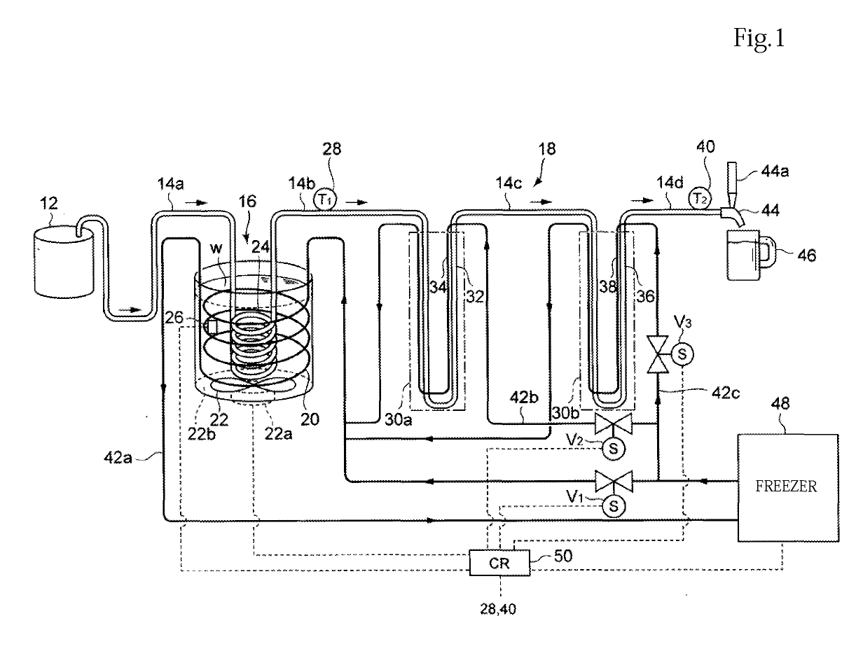

Next, with reference to FIG. 1 to FIG. 3, an embodiment of the present invention will be described. With reference to FIG. 1, in a beer server 10 according to the present embodiment, a beer supply pipe 14a is connected to a beer tank 12. On a downstream side of the beer supply pipe 14a, a primary cooling tank 16 and a secondary cooling unit 18 are connected in series through beer supply pipes 14a to 14d that are connected in series. The primary cooling tank 16 is filled with cooling water w. A refrigerant evaporation pipe 20 formed in a coil shape and having a large diameter is disposed in the primary cooling tank 16 filled with the cooling water w. A coil axis of the refrigerant evaporation pipe 20 extends in a height direction of the primary cooling tank 16.

Disposed at a lower center portion of the primary cooling tank 16 are agitation fins 22. Disposed outside a bottom wall 22b of the primary cooling tank 16 is a drive motor 22a that drives the agitation fins 22. Disposed inside the refrigerant evaporation pipe 20 is a beer cooling pipe 24 formed in a coil shape and having a diameter smaller than the refrigerant evaporation pipe 20. An upstream end of the beer cooling pipe 24 is connected to the beer supply pipe 14b. A downstream end of the beer cooling pipe 24 is connected to the beer supply pipe 14b. An ice sensor 26 that detects a thickness (amount) of ice formed on a front surface of the refrigerant evaporation pipe 20 is disposed in the primary cooling tank 1 and opposite to the refrigerant evaporation pipe 20. In addition, a temperature sensor 28 that detects the temperature of beer that flows in the beer supply pipe 14b is disposed on the beer supply pipe 14b. An upstream end and a downstream end of the refrigerant evaporation pipe 20 are connected to a refrigerant circulation path 42a.

Disposed adjacent to the primary cooling tank 16 is the secondary cooling unit 18. The secondary cooling unit 18 is composed of two heat exchangers 30a and 30b. Disposed in the heat exchanger 30a are a beer cooling pipe 32 and a refrigerant flow path 34. The heat exchanger 30a directly exchanges heat between beer that flows in the beer cooling pipe 32 and refrigerant that flows in the refrigerant flow path 34 through a heat transfer wall, but not through a heat medium. The heat exchangers are composed of for example shell and tube type heat exchangers, plate type heat exchangers, or dual-tube type heat exchangers. An upstream end of the beer cooling pipe 32 is connected to the beer supply pipe 14b. A downstream end of the beer cooling pipe 32 is connected to the beer supply pipe 14c. An upstream end and a downstream end of the refrigerant flow path 34 are connected to a refrigerant circulation path 42b.

The heat exchanger 30b has a structure same as the heat exchanger 30a. In other words, disposed in the heat exchanger 30b are a beer cooling pipe 36 and a refrigerant flow path 38 so as to directly exchange heat between beer and refrigerant not through a heat medium. An upstream end of the beer cooling pipe 36 is connected to the beer supply pipe 14c. A downstream end of the beer cooling pipe 36 is connected to the beer supply pipe 14d. An upstream end and a downstream end of the refrigerant flow path 38 are connected to a refrigerant circulation path 42c. Disposed on the beer supply pipe 14d is a temperature sensor 40 that detects the temperature of beer that flows in the beer supply pipe 14d. Disposed at an outlet of the beer supply pipe 14d is a dispensing nozzle 44 that dispenses beer cooled at nearly 0° C. to a mug 46.

The beer server 10 is provided with a freezer 48 that has a unit that composes a freezing cycle. The refrigerant evaporation pipe 20 of the primary cooling tank 16, the refrigerant flow path 34 of the heat exchanger 30a, and the refrigerant flow path 38 of the heat exchanger 30b are connected to the freezer 46 through the refrigerant circulation paths 42a to 42c, respectively. In other words, the refrigerant circulation paths 42a to 42c are disposed in parallel with the refrigerant evaporation pipe 20 and the refrigerant flow paths 34 and 38. Solenoid valves V₁, V₂, and V₃ are disposed on the refrigerant circulation paths 42a to 42c, respectively.

Detected values of the ice sensor 26 and the temperature sensors 28 and 40 are input to a control unit 50. The control unit 50 controls the drive motor 22a of the agitation fins 22 and switching operations of the solenoid valves V₁, V₂, and V₃.

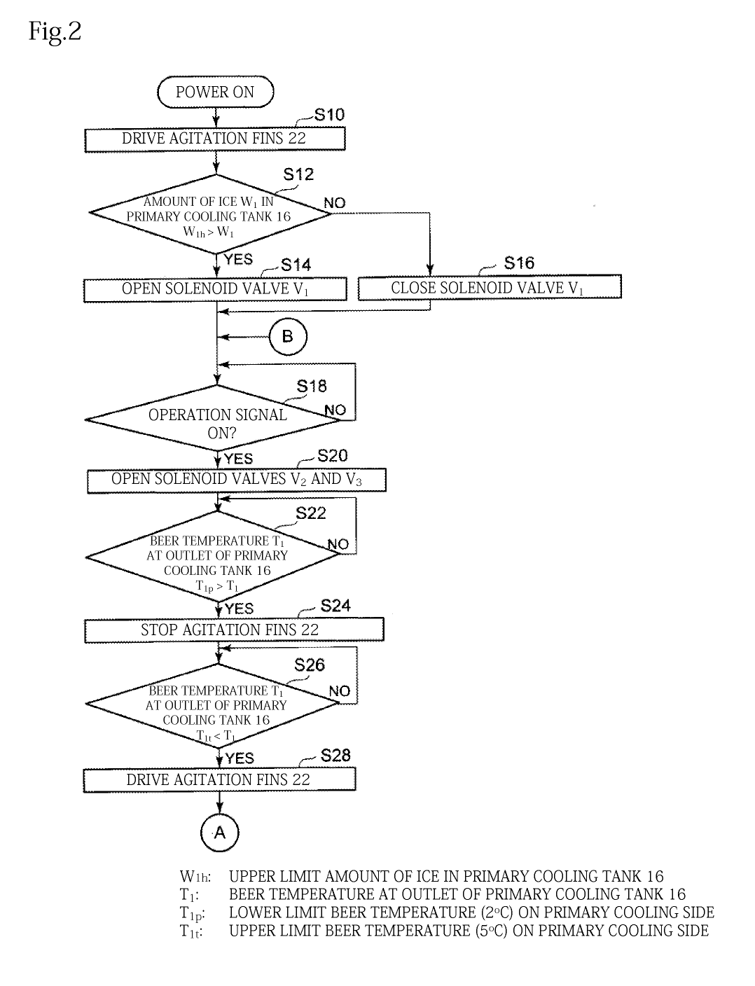

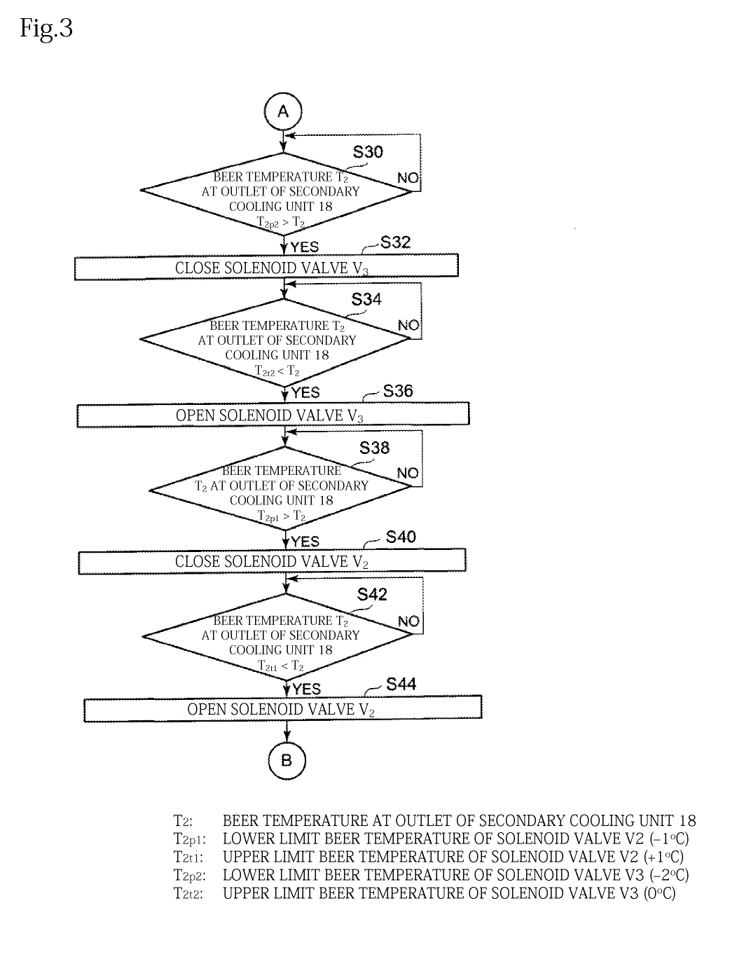

Next, with reference to FIG. 2 and FIG. 3, an operational procedure of the beer server 10 will be described. Numeric values in parentheses described in FIG. 2 and FIG. 3 represent temperatures measured at individual parts of the beer server according to the present embodiment. In FIG. 2, in a non-operating time such as at midnight, low temperature refrigerant is supplied to the primary cooling tank 16. Ice is formed on the front surface of the refrigerant evaporation pipe 20 disposed in the primary cooling tank 16. When a power supply of the beer server is turned on, the agitation fins 22 are driven (in S10). As a result, force convection occurs in the cooling water w filled in the primary cooling tank 16. Thus, the beer in the beer cooling pipe 24 is further cooled.

The ice sensor 26 detects an amount of ice formed on the front surface of the refrigerant evaporation pipe 20. When the amount of ice W₁ formed in the primary cooling tank 16 is W₁<upper limit value W₁ₕ (in S12), the solenoid valve V₁ is opened. Thus, the low temperature refrigerant is supplied from the freezer 48 to the refrigerant evaporation pipe 20. As a result, the amount of ice filled in the primary cooling tank 16 is increased to the upper limit value W₁ₕ (in S14). If W₁≧upper limit value W₁ₕ, the solenoid valve V₁ remains closed. Thus, the low temperature refrigerant is not supplied to the refrigerant evaporation pipe 20 (in S16).

When a beer cock 44a is operated and beer is dispensed from dispensing nozzle 44 to the mug 46, an operation signal is turned on (in S18). As a result, the solenoid valves V₂ and V₃ are opened (in S20). Thus, the low temperature refrigerant is supplied from the freezer 48 to the heat exchangers 30a and 30b. Consequently, beer that flows in the beer cooling pipes 32 and 36 are cooled. When the detected value of the temperature sensor 28 (a beer temperature T₁ at the outlet of the primary cooling tank 16 is T₁<lower limit temperature T₁ₚ (2° C.) (in S22), the agitation fins 22 are stopped. When the agitation fins 22 are stopped, the forced convection that occurs in the primary cooling tank 16 changes to natural convection. As a result, the amount of heat exchanged between beer that flows in the beer cooling pipe 24 and cooling water w is decreased so that the beer temperature is not further lowered. In contrast, when T1>upper limit value T1t (5° C.) (in S26), the agitation fins 22 are driven so that the amount of heat exchanged between beer and cooling water w is increased so as to lower the beer temperature (in S28).

When the detected value of the temperature sensor 40 (a beer temperature T₂ at the outlet of the secondary cooling unit 18) is T₂<T_{2P2}, (−2° C.) (in S30), the solenoid valve V3 is closed so that beer is not cooled by the secondary cooling unit 18 (in S32). In contrast, when T₂>T_{2P2} (0° C.) (in S34), the solenoid valve V3 is opened so that beer is further cooled by the secondary cooling unit 18 (in S36).

When the beer temperature T₁ at the outlet of the primary cooling tank 16 is T₁<lower limit value T_{2P1} (−1° C.) (in S38), the solenoid valve V₂ is closed so that beer is not cooled by the primary cooling tank 16 (in S40). In contrast, when T₁>upper limit value T₂ₜ₁ (+1° C.) (in S42), the solenoid valve V2 is opened so that beer is further cooled (in S44). When the beer cock 42a is operated next time, operations after S18 are repeated.

Operations from S10 to S16 are desirably performed at midnight because power consumption is low. As a result, daytime peak power consumption can be reduced.

According to the present embodiment, the control unit 50 controls the beer temperature at the outlet of the primary cooling tank 16 to a predetermined value ranging from 2° C. to 5° C. and the beer temperature at the outlet of the secondary cooling unit 18 to a predetermined value ranging from 0° C. to −2° C. As a result, the beer temperature at the outlet of the secondary cooling unit can be accurately controlled to a predetermined value. According to the present embodiment, since heat is directly exchanged between beer and refrigerant not through a heat medium, the beer is likely to be frozen. However, according to the present embodiment, since the beer temperatures are controlled at the outlet of the primary cooling tank 16 and the outlet of the secondary cooling unit 18, the beer serving temperature can be lowered to nearly 0° C., not the freezing temperature or below. Thus, since the beer serving temperature is accurately controlled, beer is not excessively cooled. As a result, power for driving the freezer 48 can be reduced.

In addition, since the heat exchangers 30a and 30b of the secondary cooling unit 18 directly exchange heat between beer and refrigerant not through a heat medium, a heat load of the beer server according to the present invention is lower than a heat load of each of conventional beer servers. As a result, power consumption of the beer server can be reduced. As a result, since a freezer having a low capacity can be used, the secondary cooling unit 18 becomes compact and inexpensive. Thus, the refrigerator 48 can be operated with a 100 V power supply that small restaurants have.

In addition, the primary cooling tank 16 and the heat exchangers 30a and 30b of the secondary cooling unit 18 are disposed in series through the beer supply pipes 14b to 14d. Moreover, the refrigerant pipes 42a to 42c are disposed in parallel with the primary cooling tank 16 and the heat exchangers 30a and 30b. The solenoid valves V₁ to V₃ are disposed on the refrigerant circulation paths 42a to 42c, respectively. As a result, the beer temperatures can be easily controlled at the outlets of the heat exchangers 30a and 30b. Thus, the beer temperature can be more accurately controlled at the outlet of the secondary cooling unit.

In addition, since the solenoid valve V₃ for controlling the beer temperature of the heat exchanger 30b that is disposed closer to the beer supply pipe 14d than the solenoid valve V₂ for controlling the beer temperature of the heat exchanger 30a is controlled earlier than the solenoid valve V₂, when the solenoid valve V₂ is not used, the beer temperature at the outlet of the beer supply pipe 14d can be quickly lowered to a predetermined value. Thus, the power consumption of the beer server 10 can be further reduced. Moreover, when low temperature refrigerant is supplied to the primary cooling tank 16 in a non-operating time in which power consumption is low, for example at midnight, and a predetermined amount of ice is formed on the front surface of the refrigerant evaporation pipe 20, the peak power consumption can be reduced.

The present invention can be applied to both alcoholic beer and non-alcoholic beer. In addition, the present invention can be also applied to other kinds of beverages such as whiskey, highball, Cyuhai (liquor mixed with soda water), juice, and tea.

### INDUSTRIAL APPLICABILITY

According to the present invention, a beer server that serves beer at a temperature of nearly 0° C., that accurately controls the beer temperature, that reduces power consumption, and that is compact and inexpensive can be accomplished.

1. A beer server comprising:
a beer tank that stores beer;
a primary cooling unit having a cooling tank storing cooling water, an agitator that agitates the cooling water, a beer cooling pipe disposed in the cooling water and through which the beer flows from the beer tank, and a refrigerant evaporation pipe disposed in the cooling water;
a secondary cooling unit having a heat exchanging part that directly exchanges heat between the beer primarily cooled by the primary cooling unit and a refrigerant not through a heat medium so as to secondarily cool the beer;
a dispensing nozzle that dispenses the beer cooled by the secondary cooling unit;
a freezer that supplies a low temperature refrigerant to the refrigerant evaporation pipe of the primary cooling unit and to the secondary cooling unit;
a first temperature sensor that detects a beer temperature at an outlet of the primary cooling unit;
a second temperature sensor that detects a beer temperature at an outlet of the secondary cooling unit; and
a control unit into which detected values of the first temperature sensor and the second temperature sensor are inputted, the control unit being configured to control an operation of the agitator to set the beer temperature at the outlet of the primary cooling unit to a predetermined value, and to control an amount of the refrigerant supplied to the second cooling unit to set the beer temperature at the outlet of the secondary cooling unit to a predetermined value.

2. The beer server according to claim 1
wherein the heat exchanging part of the secondary cooling unit includes a plurality of heat exchangers disposed in series in a flow path of the beer,
wherein the beer server comprises refrigerant supply pipes and flow rate adjustment valves, the refrigerant supply pipes being disposed in parallel with the primary cooling unit and the plurality of heat exchangers and configured to supply the low temperature refrigerant from the freezer to each of the plurality of heat exchangers and the refrigerant evaporation pipe of the primary cooling unit, and the flow rate adjustment valves being disposed in the respective refrigerant supply pipes, and
wherein the control unit controls opening degrees of the flow rate adjustment valves so as to control the amounts of the refrigerant supplied to the plurality of heat exchangers.

3. The beer server according to claim 1,
wherein the primary cooling unit has an ice storage sensor, and
wherein the control unit causes the low temperature refrigerant to be supplied to the refrigerant evaporation pipe of the primary cooling unit in a non-operating time of the beer server so that only a predetermined amount of ice is stored in the primary cooling unit.
